(19) United States
(12) Patent Application Publication
(10) Pub. No.: US 2013/0155828 A1
(43) Pub. Date: Jun. 20, 2013

(54) RECORDING METHOD AND RECORDING APPARATUS

(71) Applicants: SONY CORPORATION, Tokyo (JP); SONY DADC CORPORATION, Tokyo (JP)

(72) Inventor: Akiya Saito, Kanagawa (JP)

(73) Assignees: SONY DADC CORPORATION, Tokyo (JP); SONY CORPORATION, Tokyo (JP)

(21) Appl. No.: 13/688,436

(22) Filed: Nov. 29, 2012

(30) Foreign Application Priority Data
Dec. 14, 2011 (JP) 2011-273083

(51) Int. Cl. G11B 20/10

(52) U.S. Cl. CPC G11B 20/10
USPC 369/59.11

(57) ABSTRACT

A recording method includes: generating a laser driving pulse, of which the number depends on a length of a mark which is formed, and where a pulse level of a pulse column at least in an intermediate pulse besides the lead pulse and the last pulse is sequentially decreased; performing laser emission, based on the laser driving pulse; and performing mark formation using thermal recording by laser irradiation on a recording medium.

### CROSS-REFERENCE TO RELATED APPLICATION

The present application claims priority from Japanese Patent Application No. JP 2011-273083 filed in the Japanese Patent Office on Dec. 14, 2011, the entire content of which is incorporated herein by reference.

### BACKGROUND

The present disclosure relates to a recording method and a recording apparatus in which the shape of a mark (a pit) formed on a recording medium is optimized and a high quality reproduction signal is obtained.

In a manufacturing process of a ROM type optical disc which is only for reproduction, first, a master having a pit column pattern is made, a stamper is made from the master, and a large quantity of optical discs are produced using the stamper. The pit as a concave-convex pattern formed on the optical disc is transferred in the order of the master, the stamper and the optical disc and then the shape of the pit of the optical disc becomes the shape of the pit which is formed when the master is produced (when mastering).

A technique about a generating and developing processes of the exposure pit column on the master using an inorganic resist is disclosed in Japanese Unexamined Patent Application Publication No. 2010-123230.

### SUMMARY

When reproducing the optical disc, reflected laser light is received during irradiation of the laser light on the pit column and a reproduction signal is obtained from the reflected light. Thus, the shape of the pit influences the quality of the reproduction signal.

It is desirable to form a pit (a mark) from which a better quality reproduction signal may be obtained in a recording operation such as mastering.

According to an embodiment of the present disclosure, there is provided a recording method includes: generating a laser driving pulse, of which the number depends on a length of a mark which is formed, and where a pulse level of a pulse column at least in an intermediate pulse other than the lead pulse and the last pulse is sequentially decreased, performing laser emission, based on the laser driving pulse and performing mark formation using thermal recording by laser irradiation on a recording medium.

According to another embodiment of the present disclosure there is provided a recording apparatus includes: a laser driving pulse generation section which generates a laser driving pulse of which the number depends on a length of a mark which is formed, and where a pulse level of a pulse column at least in an intermediate pulse besides the lead pulse and the last pulse is sequentially decreased; and a recording head section which performs laser emission, based on the laser driving pulse and performs mark formation using thermal recording by laser irradiation on a recording medium.

As described above, in the present disclosure, the thermal recording is performed by using the pulse column of which the pulse level in at least the intermediate pulse as the laser driving pulse is sequentially decreased. In a case of the thermal recording, the mark shape is determined by the heat accumulation amount from the laser irradiation position to a circumference on the recording medium. The longer the mark being formed, the greater the heat accumulation amount at an end side of the mark and the greater the tendency for the mark to spread in the orthogonal direction of the track (a radial direction of the disc, if a disc medium) of the track.

In a case where the long mark is recorded with the pulse train using a plurality of intermediate pulses between the lead pulse and the last pulse as the write strategy, the level of each intermediate pulse is sequentially decreased thereby decreasing the laser power. Accordingly, the heat accumulation amount in the second half of the mark is suppressed and a mark (pit) with a uniform mark width is formed.

According to the present disclosure, the decrease may be suppressed in which the mark width is sequentially increased due to the influence of the heat accumulation. Thus, there are advantages in that the mark (pit) of which the mark width is adjusted may be formed and when performing reproduction, a mark column or pit column, from which a good quality reproduction signal may be obtained, may be formed.

### BRIEF DESCRIPTION OF THE DRAWINGS

FIG. 1 is a block diagram of a mastering device of an embodiment of the present disclosure.

FIGS. 2A to 2D are explanatory views of a manufacturing process of an optical disc.

FIGS. 3A to 3D are explanatory views of a manufacturing process of an optical disc.

FIG. 4 is an explanatory view of an example of write strategy.

FIGS. 5A and 5B are explanatory views of correction of a shape of a mark (a pit) and a length of a mark (a pit) formed by driving of laser of a pulse train.

FIGS. 6A and 6B are explanatory views of a reproduction signal waveform according to the shape of the pit.

FIG. 7 is an explanatory view of the write strategy of the embodiment.

FIG. 8 is an explanatory view of the shape of the mark (the pit) in the embodiment.

FIG. 9 is a flowchart of a strategy determination process of the embodiment.

FIG. 10 is an explanatory view of candidate strategy which is used in the strategy determination process of the embodiment.

FIG. 11 is an explanatory view of correction of last pulse of the candidate strategy of the embodiment.

FIG. 12 is an explanatory view of the correction of last pulse of the candidate strategy of the embodiment.

FIGS. 13A to 13D are explanatory views of expansion of a resist layer when exposing of the embodiment.

FIGS. 14A and 14B are SEM photos of pits of the embodiment and the related art.

### DETAILED DESCRIPTION OF EMBODIMENTS

Hereinafter, embodiments are described in the following order.

1. Configuration of Mastering Device

2. Manufacturing Process of Disc

3. Explanation of Destabilization of Pit Shape

4. Explanation of Write Strategy and Elliptical Pit of Embodiment

5. Strategy Determination Process

6. Modification Example

### 1. Configuration of Mastering Device

In the embodiment, a mastering device, which forms an exposure mark on an optical disc master, is exemplified as a recording apparatus which carries out a recording method described in claims.

In addition, the optical disc is made using a pattern on which a concave-convex pit pattern of the master is transferred, which is described below in the manufacturing process of the disc. Accordingly, a concave-convex pit (an embossing pit) formed on the optical disc has a substantially the same shape as the concave-convex pit formed on the master. In addition, in the embodiment, mastering of PTM (Phase Transition Mastering) method using an inorganic-based resist material is performed, and in this case, a portion which is exposed on the master using a mastering device is developed, thereby becoming a concave-convex pit.

In consideration thereof, for the sake of explanation, the portion which is exposed by laser light on the master is referred to as “the exposure mark” or simply a “mark” and the portion where the exposure mark portion becomes a concave shape through developing is referred to as a “pit”. Further, the concave portion of the optical disc where the pit of the master is transferred via the stamper is also referred to as a “pit”. The shape of the pit of final optical disc may be considered to be substantially the same as the shape of the exposure mark or the shape of the pit on the master.

In the embodiment, the shape of the exposure mark becomes an appropriate shape in the mastering device, however, as a result, this allows the shape of the pit of the optical disc, which is a final production, to be an appropriate shape.

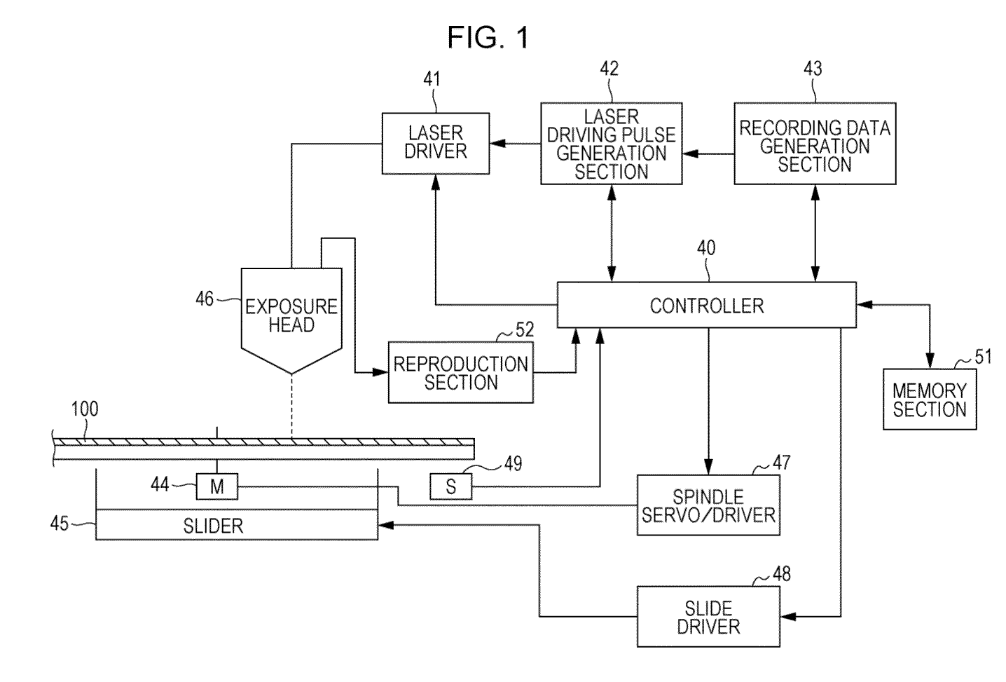

FIG. 1 illustrates a configuration example of the mastering device.

A laser source and necessary optical system for exposure are installed in an exposure head 46. The laser source performs emission, based on a driving signal from a laser driver 41.

A recording data generation section 43 generates a modulation signal which is to be recorded (exposed) on the disc master. The recording data is data which is expressed as a pit pattern on the optical disc finally manufactured. The recording data generation section 43 performs modulation on the recording data in a modulation method such as RLL(1-7)pp (RLL; Run Length Limited, pp: Parity preserve/Prohibit rmtr (repeated minimum transition runlength), and as the modulation signal, outputs the data pattern which is limited, for example, to a run length of 2T to 9T, or the like.

The modulation signal is input into a laser driving pulse generation section 42 and converted into a laser driving signal (a strategy pattern) having a pulse train shape for thermal recording. The strategy pattern is a pattern, for example, corresponding to the pit length of 2T to 9T. Specific example is described below.

The laser driving pulse generation section 42 supplies the laser driving pulse to the laser driver 41.

The laser driver 41 supplies the driving signal to the laser source for exposure inside the exposure head 46, based on the laser driving pulse.

Accordingly, the recording laser light from the laser light source for the exposure becomes the modulation light according to the laser driving pulse and the exposure mark column corresponding to the pit column is formed on a master 100.

The master 100 is driven to rotate using a spindle motor 44. The spindle motor 44 is driven to rotate while the rotation speed thereof is controlled by a spindle servo/driver 47. Thus, the master 100 is rotated, for example, at a constant linear speed or a constant angular speed.

A slider 45 is driven by a slide driver 48 and moves the entire base stand including a spindle mechanism on which the master 100 is installed. In other words, the master 100 in a rotating state with the spindle motor 44 is exposed by the optical system while moving in the radial direction using the slider 45 so that spiral-shaped tracks are formed by the exposed mark column.

The moving position, that is, the exposure position (a radial position of the disc: the radial position of the slider) of the master 100 using the slider 45 is detected by a sensor 49. The position detection information using the sensor 49 is supplied to a controller 40.

The controller 40 controls the entire mastering device. In other words, the controller 40 performs data output using the recording data generation section 43, control of a pulse generation parameter in the laser driving pulse generation section 42, setting the laser power to the laser driver 41, control of rotation operation of the spindle using the spindle servo/driver 47, control of moving operation of the slider 45 using the slide driver 48 or the like.

Specifically, in a case of the embodiment, the write strategy pattern using in the generation of the laser driving pulse is a pattern for generating the laser driving pulse configured of the pulse column in which the pulse level is sequentially decreased in at least intermediate pulses besides the lead pulse and the last pulse. As described below, the controller 40 also performs a process for determining the write strategy.

A memory section 51 comprehensively indicates a ROM (Read Only Memory), a RAM (Random Access Memory), a non-volatile memory, or the like. The non-volatile memory is a flash ROM, an EEPROM (Electrically Erasable and Programmable Read Only Memory) or the like.

The ROM or the non-volatile memory in the memory section 51 is used for storing an operation program, fixed process coefficient information, table information of the controller 40, or the like. In addition, it also used for storing the candidate strategy used in the write strategy determination process described below.

The RAM in the memory section 51 is used as a work area for processing by the controller 40.

A reproduction section 52 performs the reproduction signal process which is obtained during reproduction of the test write area in which test writing is performed during the strategy determination process described below.

As the optical system, the exposure head 46 has an optical path and a photodetector detecting the reflected light when the laser light is irradiated. The controller 40 instructs the laser driver 41 to perform laser emitting drive as continuous reproduction level light. Thus, when the exposure head 46 performs the reproduction scanning of a portion where the exposure mark is formed by the test writing according to the instruction of the controller 40, the reflected light information is supplied to the reproduction section 52.

The reproduction section 52 generates the reproduction signal from the reflected light information and detects the edge timing of the reproduction signal or the like, thereby supplying the edge timing information to the controller 40. According to the operation, the controller 40 may detect the mark edge position of an exposure mark or the mark length (length of the formed pit) which is judged from the mark edge position.

### 2. Manufacturing Process of Disk

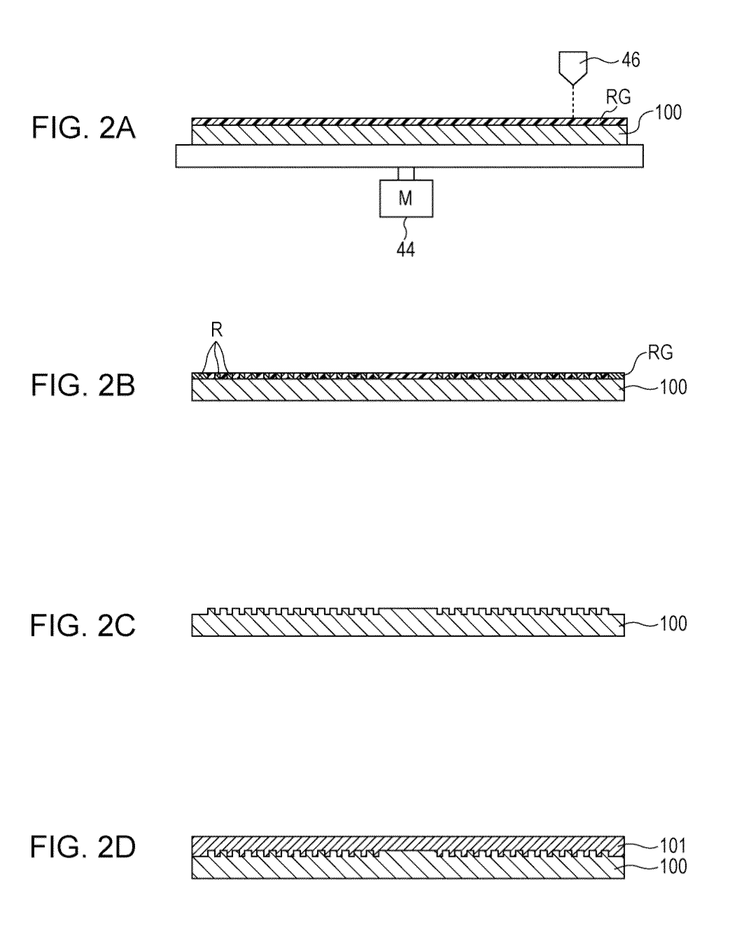

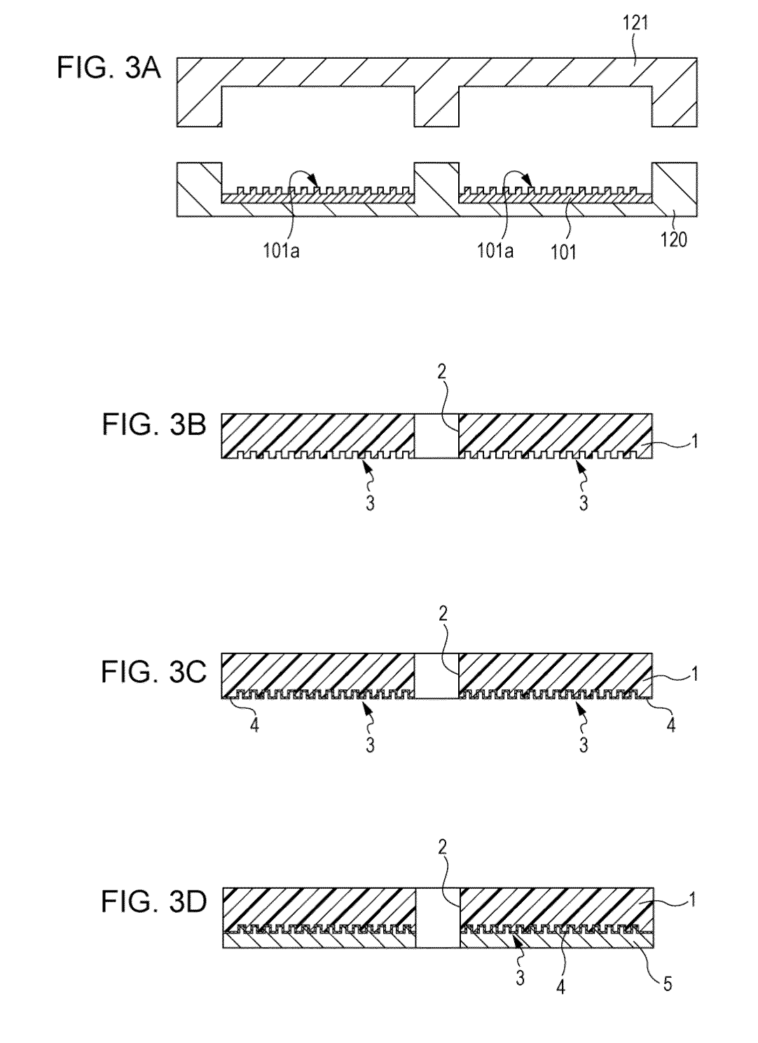

The manufacturing process of the optical disc is described with reference to FIGS. 2A to 2D and 3.

First, in order to make the master, mastering is performed using the mastering device described above.

For example, as shown in FIG. 2A, a laser beam, which is modulated according to the recording information from the exposure head 46, is irradiated on the master 100 on which the resist layer RG is formed with the inorganic resist and the exposure is performed corresponding to the formed pit pattern. Accordingly, as shown in FIG. 2B, the exposure portion R is formed.

Next, as shown in FIG. 2B, the development is performed on the exposed disc master and as shown in FIG. 2C, the master 100, on which the exposure portion becomes a concave pit, is manufactured.

Next, the stamper is made. For example, the stamper 101, on which the concavities and convexities of the master 100 are transferred by a nickel electroforming process using the master 100, is made (FIG. 2D). A portion corresponding to the pit in the concave-convex pattern 101a of the stamper 101 becomes a convex shape (FIG. 3A).

Next, disc substrate manufacturing is performed using the stamper 101.

As shown in FIG. 3A, the stamper 101 is arranged on a die for the substrate molding. The die is composed of a lower cavity 120 and an upper cavity 121, and the stamper 101 for transferring the pit column is arranged in the lower cavity 120.

As described above, for example, the substrate 1 is molded with the injection molding of polycarbonate resin using the die and the molded substrate 1 is shown in FIG. 3B.

That is, the substrate 1 formed of the polycarbonate resin is configured in such a manner that the center thereof becomes a center hole 2 and the information reading surface side becomes a pit pattern 3 where the concave-convex pattern 101a formed on the stamper 101 in the die is transferred.

Subsequently, deposition is performed on the substrate 1 formed as described above.

First, the deposition of a reflection film 4 is performed on the pit pattern transferred from the stamper 101 by sputtering. That is, as shown in FIG. 3C, for example, the Ag alloy reflection film 4 is formed on a signal reading surface side where the pit pattern 3 is formed.

Further, for example, as shown in FIG. 3D, a cover layer 5 is formed by spin-coating of ultraviolet-curable resin.

In addition, a further hard coat process may be performed on the surface of the cover layer 5.

A case of a one layer disc, in which there is one recording layer, is illustrated in the embodiment, however, a further process for each recording layer is added in a case of a multilayer disc having two or more layers.

As described above, the deposition process is processed and then printing or the like is performed on the label surface side and the optical disc is completed.

In the embodiment, the exposure mark formation as the thermal recording is performed on the inorganic resist of the master 100 in the mastering. The mastering of the PTM method is briefly described.

The resist layer RG is formed by for example, sputtering on the master 100 with the inorganic resist. As the resist material, an incomplete oxide of a transition metal is used. Specifically, the transition metal includes Ti, V, Cr, Mn, Fe, Nb, Cu, Ni, Co, Mo, Ta, W, Zr, Ru, Ag, or the like.

In addition, in order to improve exposure sensitivity of the resist layer RG, a predetermined middle layer may be formed between the master substitute and the resist layer RG.

As the resist material, the incomplete oxide of a transition metal is defined as a compound which is shifted in a direction where oxygen content is smaller than a stoichiometric composition according to the valence that may be exhibited by the transition metal, that is, as a compound in which the oxygen content in the incomplete oxide of the transition metal is smaller than the oxygen content of the stoichiometric composition according to the valence that may be exhibited by the transition metal.

For example, a chemical formula MoO₃ is exemplified and described as the oxide of the transition metal. When the oxidation state of the chemical formula MoO₃ corresponds to a composition ratio Mo₁₋ₓOₓ of the composition state, it may be said that it is an incomplete oxide in which the oxygen content is smaller than that of the stoichiometric composition when 0<x<0.75 while it may be said that it is a complete oxide when x=0.75.

In addition, the transition metal may form an oxides in which the valences of one transition metal are different, and in this case, real oxygen content may be smaller than that of the stoichiometric composition according to the valence that may be exhibited by the transition metal. For example, regarding Mo, the trivalent oxide (MoO₃) described above is the most stable, however, in addition thereto, a monovalent oxide (MoO) may also be present. In this case, when calculating the composition ratio Moᵢ₋ₓOₓ, it may be said that there is an incomplete oxide in which the oxygen content is smaller than that of the stoichiometric composition when 0<x<0.5. In addition, the valence of the transition metal oxide may be analyzed with a commercial analyzer.

The incomplete oxide of the transition metal absorbs ultraviolet rays or visible light and the chemical properties change with the irradiation of the ultraviolet rays or the visible light. As a result, a so-called selection ratio, in which a difference in etching speeds occurs between the exposure portion and non-exposure portion in the development process while being the inorganic resist, is obtained. In addition, the resist material composed of the incomplete oxide of the transition metal is configured such that the pattern of a border portion between the non-exposure portion and the exposure portion becomes clear and resolving power may be increased because the particle size of the film material is small.

However, since the characteristics of the incomplete oxide of the transition metal as the resist material are changed according to the degree of the oxidation, the optimal degree of the oxidation is selected as appropriate. For example, in the incomplete oxide where the oxygen content thereof is much smaller than that of the stoichiometric composition of the complete oxide of the transition metal, there is an deficiency that a large irradiation power is necessary in the exposure process and a long time is taken for a development process. Thus, an incomplete oxide for which the oxygen content is slightly smaller than that of the stoichiometric composition of the complete oxide of the transition metal is desired.

The specific transition metal configuring the resist material described above includes Ti, V, Cr, Mn, Fe, Nb, Cu, Ni, Co, Mo, Ta, W, Zr, Ru, Ag, or the like. In the elements, it is preferable that Mo, W, Cr, Fe, and Nb be used, and specifically, it is preferable that Mo and W be used from the viewpoint that a large chemical change is obtained by the ultraviolet rays or the visible light.

In the PTM method, the laser light is irradiated from the semiconductor laser to the master 100 on which the inorganic resist is coated and the exposure is performed as the thermal recording.

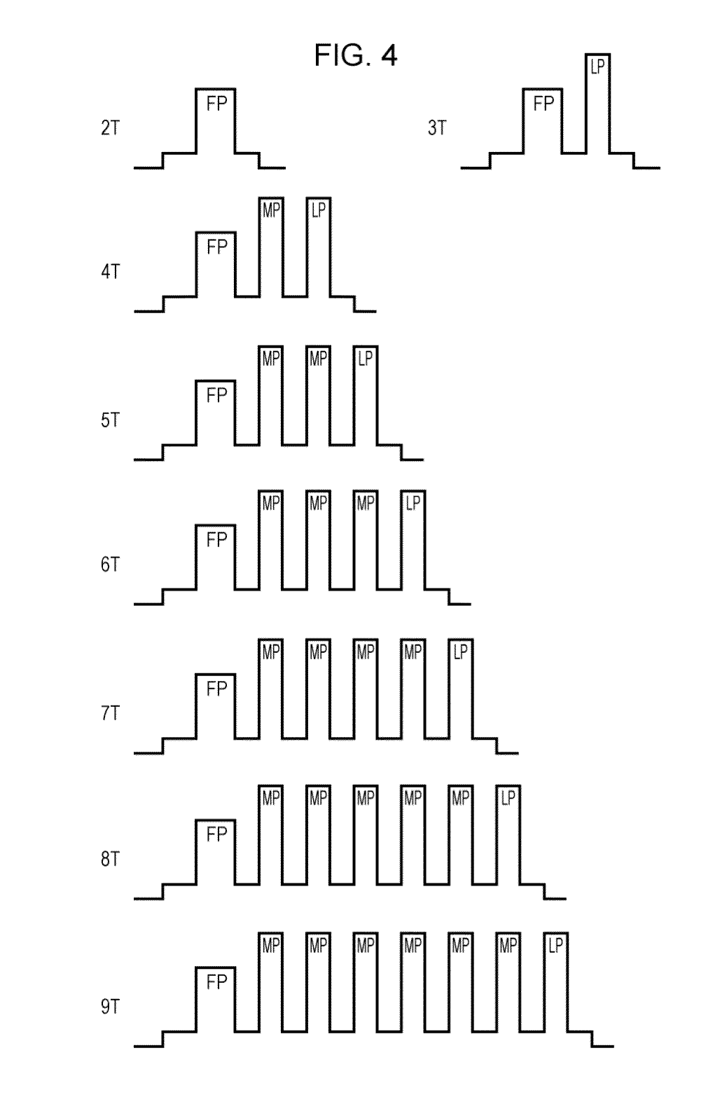

In this case, in order to provide the uniformity of the pit width by suppressing accumulation of the heat due to the laser irradiation, usually as shown in FIG. 4 described below, the exposure is performed with the emission operation, based on the laser driving pulse. In other words, in this case, generally an NRZ modulation signal synchronized with the clock is converted into a pulse signal having a time width shorter than the clock period according to the length of an H level thereof and the power is supplied to the semiconductor laser which may be directly modulated in synchronization with the converted pulse modulation signal. Accordingly, the laser output is performed as the pulse emission according to the pit length. When the development process is performed after exposure is performed as the thermal recording by the pulse emission, the concave-convex pit shape is formed as described in FIG. 2C.

### 3. Explanation of Destabilization of Pit Shape

As writing method to the optical disc, the write strategy waveform using the pulse column is generally used. In the mastering device of the embodiment described above, the laser driving pulse generation section 42 generates the laser driving pulse, based on the write strategy waveform according to the pit length which is recorded.

In addition, it is common that after writing, the edge position of the signal is measured and the write strategy waveform is adjusted to perform feedback so that the edge position approaches as near as possible to a predetermined position.

However, even though the edge position (in the length direction) may be adjusted correctly relating to the shape of the pit formed by the pulse column, until now, there has only been a method of certification of the shape of the pit relating to the width direction thereof with the observation using a SEM (scanning electron microscope).

An example of a general write strategy waveform is illustrated in FIG. 4. The waveforms are an example of the write strategy waveform corresponding to each pit length of 2T to 9T (T is a channel clock period). Usually, a method, in which (n−1) pulses are generated with respect to the pit of the channel clock length (n)T, is used.

The strategy pattern corresponding to 2T is configured of a first pulse (a lead pulse) FP which is set to a certain level and pulse width.

The strategy pattern corresponding to 3T is configured of the first pulse FP and the last pulse (the final pulse) LP which are set to certain levels and pulse widths respectively.

The strategy patterns corresponding to 4T to 9T are configured of the first pulse FP, a multi-pulse (an intermediate pulse) MP and the last pulse LP which are set to given levels and pulse widths respectively. Each of 4T to 9T is a pattern in which the number of multi-pulses MP arranged between the first pulse FP and the last pulse LP are different from each other.

The multi-pulse MP and the last pulse LP are composed of the same pulse level.

For example, the laser driving pulse generation section 42 of the mastering device generates the strategy patterns of 2T to 9T and selects the strategy pattern according to the run length of the modulation signal supplied from the recording data generation section 43 and then outputs the selected strategy pattern as the laser driving pulse.

Based on this, the exposure head 46 performs the laser irradiation so that the exposure mark is formed on the master 100 in order to form a pit having the pit length according to the recording data.

However, as described above, even though an edge position adjustment of the pit (the mark) is performed, a width adjustment of the pit (the mark) is difficult. For example, repeating the SEM observation and then the width adjustment incurs a huge amount of effort.

Thus, that the edge position of the pit which is formed is adjusted and then only the pit length is optimized is the present condition. Therefore, a droplet shape or the like is frequently formed as the pit shape.

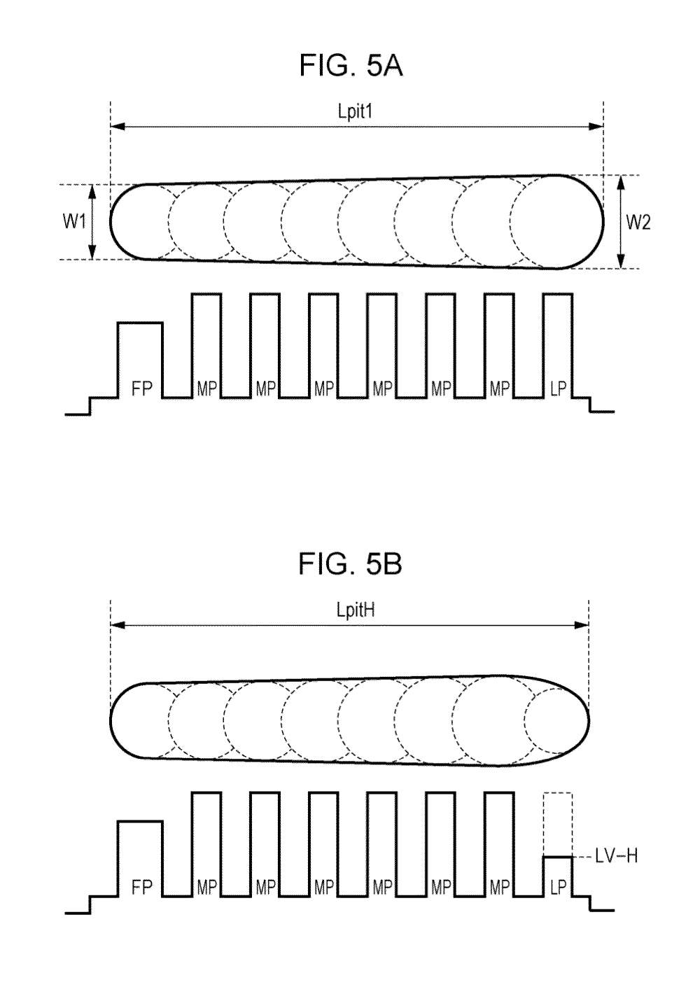

The pit shape is schematically illustrated in FIGS. 5A and 5B.

FIG. 5A illustrates a case where the exposure mark (the pit) is formed with the write strategy waveform of 9T in FIG. 4. The laser emission is performed according to the pulses and circles illustrated by dashed lines illustrating a range which is exposed by the thermal recording at the irradiation position of the laser spot as images following the laser spot. In other words, the images are schematically illustrated in which pits having concentric circular shapes with respect to each pulse emission are formed. The shape of the pit becomes a shape which is illustrated by a thick line connecting each circle. Primarily, this type is considered to be a substantially correct model.

In the formation of the pits (the exposure marks), in a case where the formation method is a thermal phenomenon, the heat amount held on the master surface influences the pit formation. In the high-speed writing in recent years, since the next pulse emission occurs before the heat which is applied by the immediately preceding pulse is diffused, there is a tendency for the heat to sequentially accumulate in the master surface. According to the effect described above, the tendency for the exposure mark to sequentially become large rearwards is seen clearly in the write strategy waveform in the pulse column having the same shape and the same strength, as shown in FIG. 5A. In other words, the shape of the mark which is formed becomes a droplet shape in such a manner that a width W2 of the end side is larger than a width W1 of the lead side of the mark. The result of the exposure being performed causes the shapes of the pits which are formed to have the same droplet shape.

In addition, it is possible for the pit length to be relatively easily adjusted. For example, in a case of FIG. 5A, the pit length Lpit1 is in a state where the length thereof is longer than the original pit length of 9T, which is a target, by increasing of the heat accumulation amount in the second half.

Regarding the pit length, the reproduction is performed after forming the pit and then the edge position of the pit may be measured by detecting the edge of the reproduction signal. Thus, when the pit length is not appropriate, the write strategy waveform is adjusted.

For example, as shown in FIG. 5B, the level of the last pulse LP is adjusted to a correction level LV-H. Accordingly, as shown in the drawing, the heat accumulation range in the length direction is decreased and the pit length is optimized as illustrated in the pit length LpitH.

Even though the pit length is adjusted as described above, the shape of the pit is not uniform in the width direction. The adjusted portion is only the end edge position of the pit. The shape of the pit becomes large rearwards until reaching the end portion.

In the write strategy waveform after adjustment of a predetermined pit length, when the emission strength of the pulse has a great difference between the adjusted pulse and the pulse immediately preceding the adjusted pulse, it is supposed that the pit formation does not produce the same size in each pulse emission due to the heat accumulation effect.

In addition, the pits which are formed in each pulse emission may be substantially closely the same as each other in the length direction and the width direction, and when the adjustment is necessary at the end portion of the pits in the length direction, it is supposed that non-uniformity also occurs (for example, the width is sequentially increased or the like) in the width direction.

When the shape of the pit is a droplet shape, since the condition of a rising/falling response of a thin portion in the pit width and the condition of the response in the thick portion in the pit width are different to each other when reading the information with the optical pickup of the reproduction apparatus, it becomes an asymmetrical response with the rising and the falling of the pit.

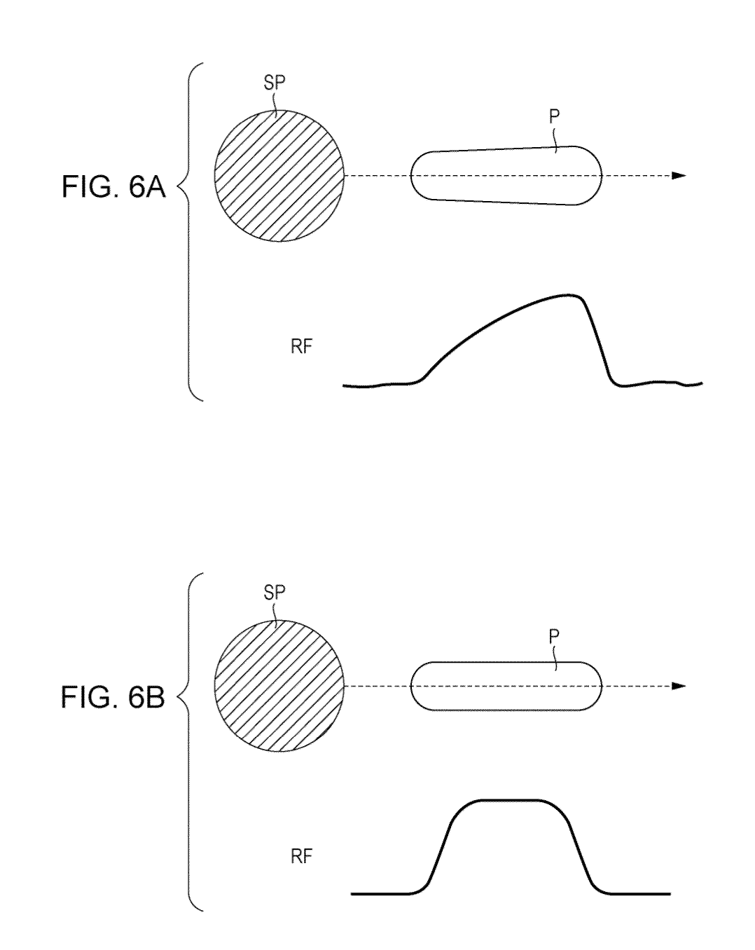

An example is illustrated in FIGS. 6A and 6B. FIG. 6A illustrates the reproduction signal (the RF signal) waveform when performing the scanning on the pit P having the droplet shape with a reproduction laser spot SP. As shown in the drawing, the RF signal waveform easily becomes an asymmetric waveform in a track line direction.

As described above, the quality of the reproduction signal is decreased, and thereby a failure may occur when reading the signal or optimizing of the reading.

Ideally, as shown in FIG. 6B, it is preferable that the pit P having a uniform pit width be formed. In this case, the RF signal waveform may be high quality signal waveform without the asymmetry.

### 4. Explanation of Write Strategy and Elliptical Pit of Embodiment

In the embodiment, the edge position in the length direction thereof is measured and the information of the width direction is obtained easily in the mark (the pit) formation using the write strategy waveform using the pulse column, and thereby the control of the width direction of the pit is performed without measuring with a SEM or the like. Accordingly, the shape of the pit becomes an elliptical shape as shown in FIG. 6B and the problems in a case where the shape of the pit becomes the droplet shape described above are solved.

In the embodiment, the laser driving pulse is configured in such a manner that the number of the pulses depends on the mark length which is formed and at least the intermediate pulse besides the lead pulse and the last pulse is the pulse column which is sequentially decreased in the pulse level.

In the mastering device, the laser driving pulse generation section 42 generates the laser driving pulse described above. Thus, the exposure head 46 performs laser emission based on the laser driving pulse thereof, and the exposure mark formation (pit formation thereafter) is performed on the master 100 that is the recording medium as the thermal recording using laser irradiation.

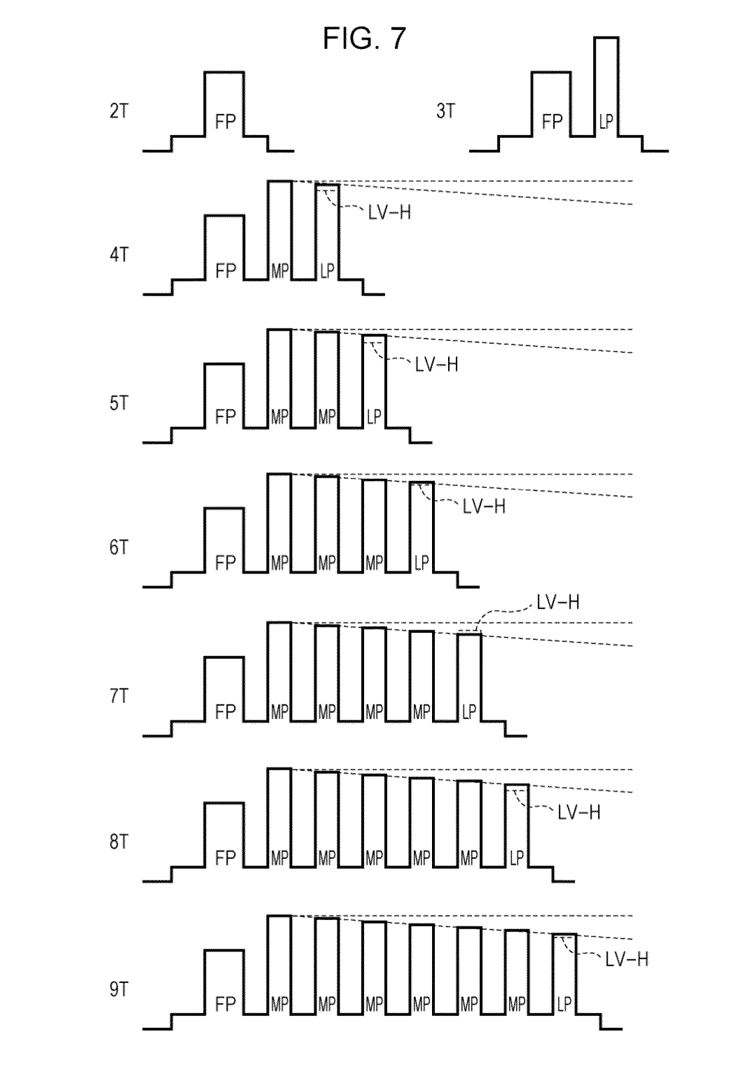

For example, when the laser driving pulse has the number of the pulses depending on the mark length which is formed and has a pulse column in which the pulse level of the intermediate pulse is sequentially decreased in a constant ratio, the write strategy waveform corresponding to each pit length of 2T to 9T is illustrated in FIG. 7.

The generation of (n−1) pulses with respect to the pit of channel clock length (n)T is similar to FIG. 4 described above.

The strategy pattern corresponding to 2T is configured of the first pulse FP which is set to a certain level and pulse width.

The strategy pattern corresponding to 3T is configured of the first pulse FP and last pulse LP which are set to certain levels and pulse widths respectively.

The strategy patterns corresponding to 4T to 9T are configured of the first pulse FP, the multi-pulse MP and last pulse LP which are set to certain levels and pulse widths respectively. Each of 4T to 9T is a pattern in which the number of multi-pulses MP arranged between the first pulse FP and the last pulse LP are different from each other.

Thus, in the pulse configuration, the height of each pulse is sequentially decreased at a constant ratio of the multi-pulse MP to the last pulse LP. The horizontal dashed line is the level of the initial multi-pulse MP and an oblique dashed line is a line connecting the top point level of each pulse.

Basically, the multi-pulse MP and the last pulse LP are configured in such a manner that the level thereof is set to decrease as going rearwards.

In addition, the level correction is performed on the last pulse LP during the strategy determination process described below. The correction level LV-H is illustrated with a dashed line. The last pulse LP is not decreased at a constant ratio from the multi-pulse that is immediately preceding the last pulse by the correction level LV-H. Occasionally, the last pulse LP may have a level higher than the multi-pulse MP that is immediately preceding the last pulse. The level correction amount of the last pulse LP is different from each T.

Thus, the level of final last pulse LP is not settled and the height of each pulse in the multi-pulse MP is sequentially decreased in a constant ratio.

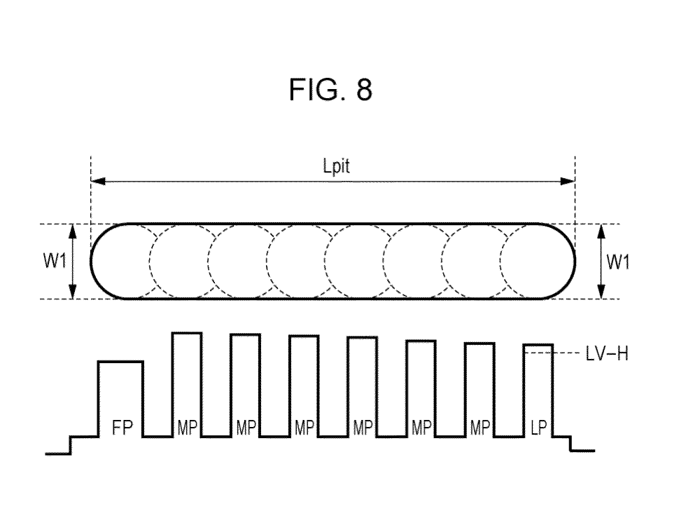

Description is made with reference to the schematic view of FIG. 8 similar to FIGS. 5A and 5B described above.

In the write strategy waveform illustrated in FIG. 7, the adjustment is carried out in such a manner that the pit is formed with the uniform size in each pulse emission, assumed that the heat accumulation effect is present on the recording medium.

That is, in order to cancel the heat accumulation effect, the strength of the pulse emission of the laser light is sequentially decreased rearward of the pit. As a result, as shown in FIG. 8, the elliptical shape of the pit, in which the width W1 in the length direction is maintained, may be realized.

If necessary, the level of the last pulse LP becomes the correction level LV-H and the pit length Lpit is adjusted, and then a pit having a substantially elliptical shape may be realized.

As described above, at least the intermediate pulse performs the laser emission, based on the laser driving pulse configured of the pulse column of which the pulse level is sequentially decreased, and performs the exposure mark formation as the thermal recording with the laser irradiation on the recording medium so that the mark (and the pit thereafter) having a substantially ideal shape may be realized.

When the shape of the pit is substantially elliptical, the reproduction signal having good symmetry as shown in FIG. 6B may be obtained and the quality of the reproduction signal may be improved.

However, in practical application, it is difficult to determine what degree of ratio is necessary when decreasing the pulse to make the shape of the pit having an ideal shape as shown in the drawing. In practical application, it varies according to the difference in the inorganic resist materials of the resist layer RG on the master 100 which is the recording medium, differences in the configurations of the layer, characteristics of optical system about the laser irradiation from the exposure head 46, the spot size, and the like.

The strategy determination process described below is performed before the practical recording operation (the mastering).

### 5. Strategy Determination Process

As described above, it may not be determined at once that the pit having a uniform width may be formed when strength of the pulse is weak to what extent. Thus, in order to set appropriate write strategy waveform, the strategy determination process is performed.

In the mastering device of the embodiment, the controller 40 performs the write strategy determination process for generation of the laser driving pulse in the following order.

First, a plurality of candidate strategies is prepared which differ in the degree of decrease in the pulse level from the multi-pulse MP to the last pulse LP.

In addition, a laser driving pulse is generated using each candidate strategy and the test writing is performed on the recording medium.

Next, the level correction of the last pulse is performed for optimizing the mark length formed on the recording medium by the test writing to each candidate strategy.

After that, one candidate strategy in a plurality of candidate strategies is selected, based on the correction amount of the level correction and the selected candidate strategy is the write strategy for the generation of the laser driving pulse.

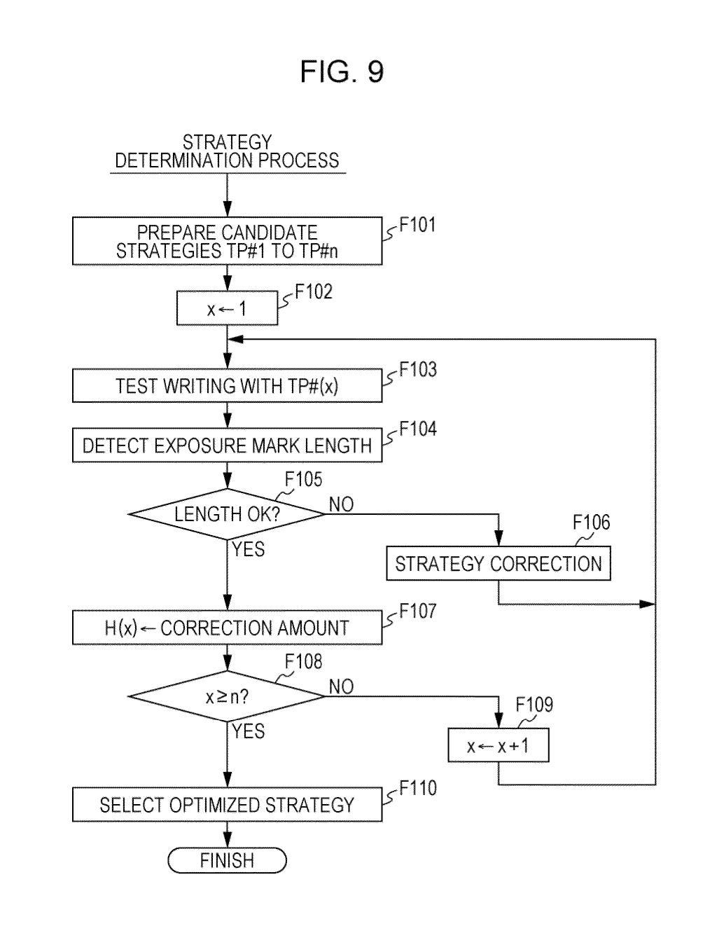

A specific example of the strategy determination process described above is described using FIGS. 9 to 13D.

FIG. 9 illustrates the process of the controller 40 for carrying out the strategy determination process.

First, in step F101, the controller 40 prepares a plurality of candidate strategies TP (TP#1 to TP#n).

Each candidate strategy TP is configured in such a manner that degree of the level decrease between the multi-pulse MP and the last pulse LP is different.

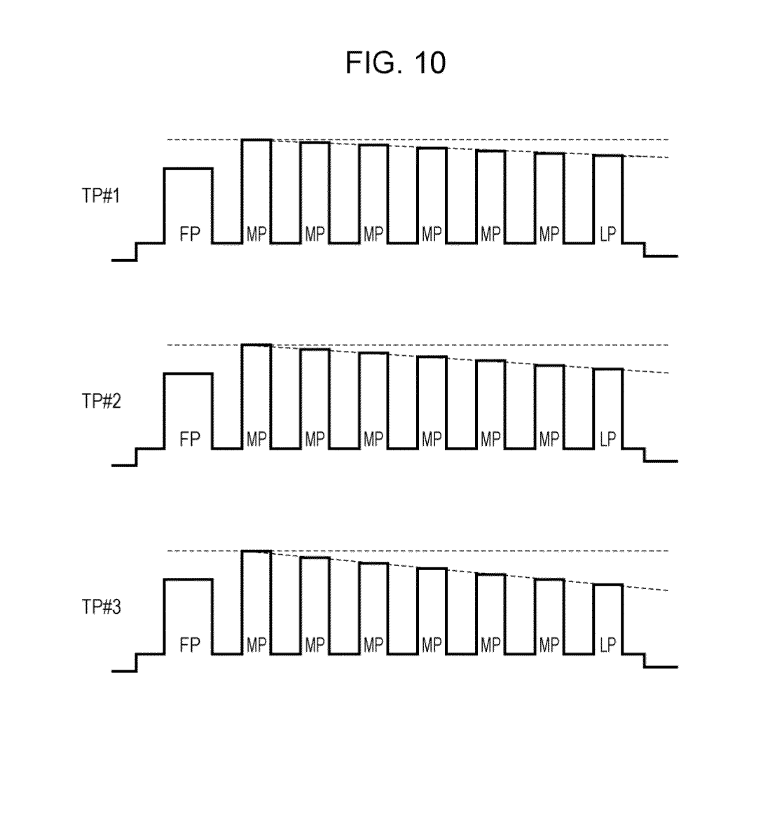

FIG. 10 illustrates an example using, for example, three candidate strategies TP#1 to TP#3. As understood by the drawing, in the candidate strategies TP#1, TP#2 and TP#3, the pulse levels are decreased sequentially in a constant ratio as shown in oblique dashed lines respectively and the degree of the decreasing of the pulse level is different to each other. In the example, the candidate strategy TP#1 has the lowest degree of the decrease and the candidate strategy TP#3 has the largest degree of the decrease.

For example, the candidate strategy TP#1 is decreased by 5% in the pulse level from the multi-pulse MP to the last pulse LP, the candidate strategy TP#2 is decreased by 7% and the candidate strategy TP#3 is decreased by 10%. As described above, the pulse levels are decreased in a constant ratio respectively and the degrees of the decreased are different to each other.

In addition, in FIG. 10, only the strategy waveform corresponding to the 9T mark is illustrated, however, one candidate strategy is a set of write strategy waveforms of 2T to 8T as illustrated in FIG. 7.

For example, as the candidate strategy TP#1, each strategy waveform 2T to 9T is prepared. For example, the waveform of 8T of the candidate strategy TP#1 is configured in such a manner that the last pulse LP of the waveform of 9T illustrated in FIG. 10 is not present and the multi-pulse MP immediately preceding the last pulse becomes the last pulse LP with the level thereof without change.

The candidate strategies TP#1 to TP#n used in the strategy determination process are, for example, stored in the memory section 51 and when performing the strategy determination process, the controller 40 may be read from the memory section 51.

In addition, that three candidate strategies TP#1 to TP#3 are used is an example, and the number of strategies may be two or four or more.

If the candidate strategies TP#1 to TP#n are prepared, the controller 40 set a variable x to “1” in step F102 and the process proceeds to step F103.

In step F103, the controller 40 carries out the test writing with the candidate strategy TP#(x).

Specifically, the test write data having each pit pattern of 2T to 9T is output from the recording data generation section 43. Thus, the candidate strategy TP#(x) is set to the laser driving pulse generation section 42 and the pulse of the candidate strategy TP#(x) is generated according to the test write data and then the pulse is supplied to the laser driver 41 as the laser driving pulse. The laser source is driven according to the pulse of the candidate strategy TP#(x) in the exposure head 46 and thereby the laser irradiation is performed on the master 100. Accordingly, the exposure marks having the length of T respectively are formed on the master 100.

When the variable x=1, the test writing is performed using the candidate strategy TP#1.

In step F104, the controller 40 reproduces the area on which the test writing is performed on the master 100 and then performs detection of the length of the exposure mark.

In the test writing, exposure is performed on the resist layer RG with the inorganic resist using the laser spot and in a case of the inorganic resist material, there is characteristic that the exposure portion changes in quality and protrudes.

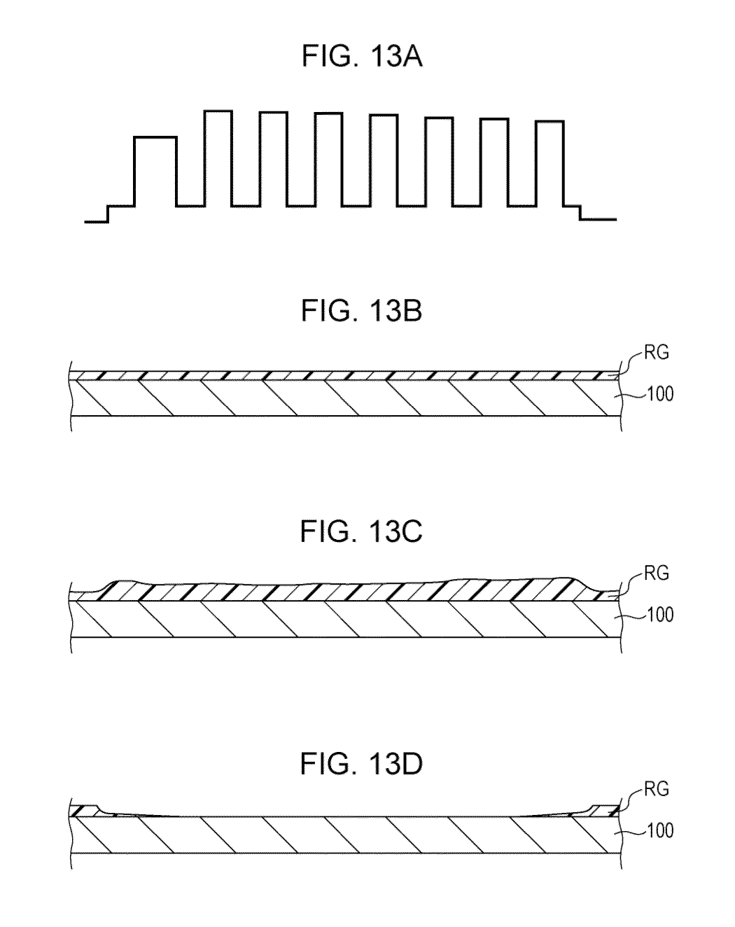

FIG. 13A illustrates the write strategy waveform of, for example, the pit of 9T and when the laser modulation is performed using the pulse and the exposure is performed, the resist layer RG on the master 100 as shown in FIG. 13B protrudes as shown in FIG. 13C.

In the practical manufacturing process, as shown in FIG. 13D, after that, the exposure portion becomes a concave pit through the development process and the protrusion state shown in FIG. 13C becomes a state where a convex pit is formed conversely.

In step F104, the exposure portion protrudes as shown in FIG. 13C by the test writing. Continuous irradiation of the laser light of the reproduction power (power which does not cause the inorganic resist to change in quality due to the heat) is performed on the exposure mark column described above. Accordingly, different reflecting light amounts may be detected in the exposure portion and the non-exposure portion. This becomes the reproduction signal of the information of the pit column as the pit/land formed on the disc master 100.

The reproduction section 52 generates the reproduction signal and detects the edge timing of the reproduction signal. Thus, the information of the edge timing is supplied to the controller 40 and then the controller 40 may detect the mark length (or the position of the mark edge) of the exposure mark which is formed.

For example, in the test writing using the candidate strategy TP#1, the exposure marks of 2T to 9T are formed and the mark lengths of the exposure marks of 2T to 9T may be detected respectively.

In step F105, the controller 40 determines whether or not the mark length is appropriate. For example, it is determined whether or not all mark lengths of exposure marks of 2T to 9T are within permissible ranges centered on a predetermined target mark lengths.

When a mark, the length thereof is not within the permissible range, is present, the process proceeds to step F106 and the controller 40 performs the strategy correction. This adjusts the level of the last pulse of the candidate strategy TP#(x).

For example, specifically, the level of the last pulse LP of each waveform of 2T to 9T in the candidate strategy TP#1 is corrected.

That is, for example, when the mark length of the mark of 9T is longer than the permissible range centered on the target mark length of 9T, the level of the last pulse LP of the write strategy waveform for 9T in the candidate strategy TP#1 is decreased. The level decrease amount may be set according to the difference between the determined mark length and the target mark length of 9T.

Conversely, for example, when the mark length of the mark of 9T is shorter than the permissible range centered on the target mark length of 9T, the level of the last pulse LP of the write strategy waveform for 9T in the candidate strategy TP#1 is increased. The level increasing amount may be set according to the difference between the determined mark length and the target mark length of 9T.

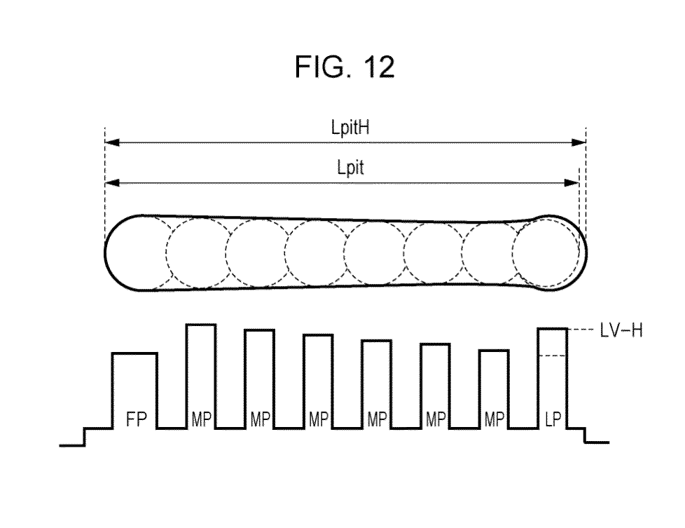

FIG. 12 illustrates a case where the pit length Lpit which is formed is shorter than the pit length of original 9T, and in this case, the level of the last pulse LP is increased as shown in the drawing and thereby the exposure mark of the target pit length LpitH may be formed.

As described above, the level correction is performed on each write strategy waveform of 2T to 9T, if necessary.

Thus, if the correction is performed on the candidate strategy TP#1, the process proceeds to step F103 and the test writing is performed again using the candidate strategy TP#1.

Accordingly, first, the test writing using the candidate strategy TP#1 is carried out while performing the strategy correction until each mark length is optimized.

If it is determined that the mark length of each T is optimized at a certain point of time, the process proceeds from step F105 to step F107 and the controller 40 stores the correction amount H(x).

The correction amount is a value indicating the correction amount given to the candidate strategy TP#(x) when the mark length is finally optimized.

For example, at this point of time, as shown in FIG. 7, the last pulse LP becomes the correction level LV-H of each T in the process of step F106 with respect to the candidate strategy TP#1.

The correction amount stored as H(x) (in this case, H1, since x=1) is considered to be the total of the differences between the correction level LV-H and the initial pulse level of each last pulse LP of each write strategy waveform of 2T to 9T or an average value of the differences thereof. Practically, since it is assumed that the pit width is increased by the heat accumulation, for example, the correction amount may be the total of the differences between the correction level LV-H and the initial pulse level of each last pulse LP of each write strategy waveform of 4T to 9T or an average value of the differences thereof.

Otherwise, the write strategy waveform for 9T (or for other T) is adopted as a representative value and then the correction amount may be the difference between the correction level LV-H of the last pulse LP in the write strategy waveform for 9T and the initial pulse level before correction.

If the correction amount H1 is stored, successively, in step F108, it is confirmed whether or not the variable x reaches total number n of the candidate strategy TP, and if the variable does not reach the total number n, incrementing of the variable x is performed in step F109 and the process returns to step F103. That is, the controller 40 successively performs the process of step F103 to step F107 using the candidate strategy TP#2. Accordingly, the test writing is performed using the candidate strategy TP#2 and the write strategy waveform of each T of the candidate strategy TP#2 is corrected so that the predetermined pit length is obtained. Thus, the correction amount H2 is stored.

In addition, if the process of step F103 to step F107 is completed relating to the candidate strategy TP#2, the increment of the variable x is performed in step F109 and the process returns to step F103. That is, the controller 40 successively performs the process of step F103 to step F107 using the candidate strategy TP#3. Accordingly, the test writing is performed using the candidate strategy TP#3 and the write strategy waveform of each T of the candidate strategy TP#3 is corrected so that the predetermined pit length is obtained. Thus, the correction amount H3 is stored.

As shown in FIG. 10, if 3 types of candidate strategies TP#1 to TP#3 are used, when the process of the step F103 to step F107 is completed using the candidate strategy TP#3, the variable x reaches the number n of the candidate strategy and the process proceeds from the step F108 to step F110.

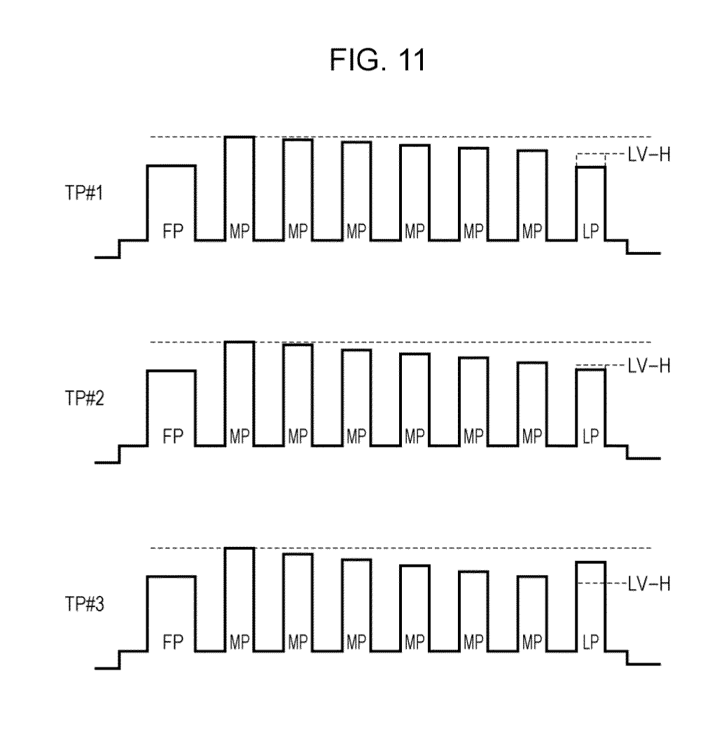

At this point of time, the waveform of each of candidate strategies TP#1 to TP#3 is corrected to a state where optimized pit lengths are formed respectively. For example, FIG. 11 illustrates a state where the last pulse LP of the write strategy waveform for 9T becomes the correction level LV-H in each of candidate strategies TP#1 to TP#3.

Thus, at this point of time, the amounts of the correction, which is performed for optimizing the pit lengths in each of candidate strategies TP#1 to TP#3, are stored as correction amounts H1, H2 and H3.

The controller 40 selects one candidate strategy, based on the correction amounts H1, H2 and H3, and allows the selected candidate strategy to be the optimized write strategy for generation of the laser driving pulse.

For example, specifically, the correction amounts H1, H2 and H3 are compared and the candidate strategy having the correction amount with the smallest value is the optimized write strategy for generation of the laser driving pulse.

As described above, the optimized write strategy waveform is determined and the process of FIG. 9 is finished.

After that, when mastering in practice, the optimized write strategy waveform is set to the laser driving pulse generation section 42 and the mastering exposure is carried out using the write strategy waveform.

As a result, in this case, as shown in FIG. 8, the exposure marks (pits after development) having a substantially uniform width may be formed with respect to 2T to 9T.

It depends on the following reasons.

In the embodiment, the pulse column as the write strategy waveform is basically a pulse column of which the level is sequentially decreased from the multi-pulse MP to the last pulse LP. Accordingly, the decrease may be suppressed in which the mark width is sequentially increased due to the effect of the heat accumulation.

However, measurement of the influence of the heat accumulation amount is difficult, and then it is difficult to determine how much degree of the decrease in the pulse level in the write strategy waveform, in which the exposure mark formation is practically performed, is optimized.

Thus, the correction is performed on the candidate strategy TP while performing the test writing using a plurality of candidate strategies TP#1 to TP#n of which the degrees of decrease of the pulse levels are different to each other so that the mark length of each T becomes the target length.

Here, as described above, the mark (the pit) formed in each pulse emission may be approximately closely the same each other in the length direction and the width direction. Thus, when adjustment in the length direction is necessary with the end portion of the pit, it is supposed that non-uniformity also occurs (for example, the width is sequentially increased or the like) in the width direction.

When considering this, it may be presumed that if the correction amount, which is given to adjust the pit length in each of candidate strategies TP#1 to TP#n, is increased by the test writing, the change in the width direction is increased. In other words, it may be considered that the candidate strategy TP having a large correction amount is not appropriate in the degree of the decrease of the pulse level.

For example, in a case of the candidate strategy TP#1 in FIG. 11, the last pulse LP is decreased relatively largely to adjust the pit length. It may be presumed that the decrease of the level from the multi-pulse MP to the last pulse LP of the candidate strategy TP#1 is too small in the degree of the decrease thereof, and as a result, the pit width is sequentially increased due to the influence of the heat accumulation.

In addition, in a case of the candidate strategy TP#3, the last pulse LP is increased relatively largely to adjust the pit length. It may be presumed that the decrease of the level from the multi-pulse MP to the last pulse LP of the candidate strategy TP#3 is too large in the degree of the decrease thereof and energy for the mark formation is sequentially decreased, and then the pit width is sequentially narrowed even though influence of the heat accumulation is present.

Meanwhile, in the candidate strategy TP#2, the correction amount of the last pulse LP is small. That the correction amount is small means the mark length is near the optimized state as appropriate with each pulse level of the candidate strategy TP#2. Thus, it may be presumed that the mark is formed substantially uniformly in the width direction. In other words, the degree of the decrease of the level from the multi-pulse MP to the last pulse LP of the candidate strategy TP#2 is appropriate, the balance with the influence of the heat accumulation is maintained, and the energy of the mark formation is changed relatively uniformly and thereby it may be presumed that the pit width is constantly formed.

It may be supposed that the candidate strategy TP having the smallest correction amount is the optimized write strategy waveform.

Even though the heat accumulation amount may not be measured, the pit having substantially the same width with the elliptical shape may be formed and then the pit having good reproduction signal quality may be formed using the write strategy waveform.

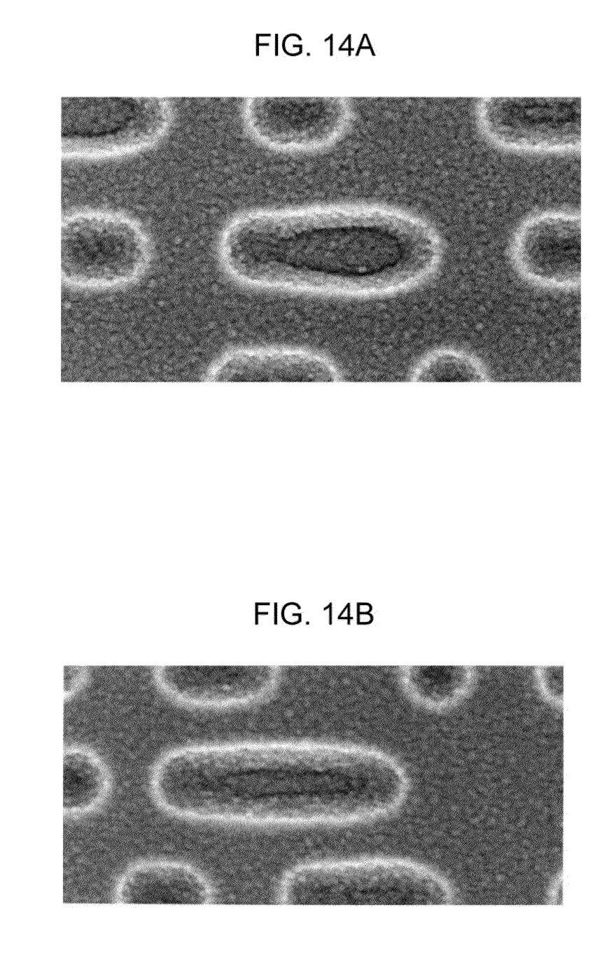

FIG. 14B is a SEM photograph of the pit in which the adjustment described above is practically performed and then the width of the shape of the pit is controlled. In addition, FIG. 14A illustrates the pit using the pulses (the pulses in which only the last pulse LP is corrected to adjust the pit length) of the uniform level as shown in FIGS. 5A and 5B.

In the example of FIG. 14A where the adjustment in the width direction is not performed, the droplet-shaped pit, of which the width is also increased rearward (in the right direction) on the SEM photograph, is observed.

Meanwhile, in a case of FIG. 14B using the method of the embodiment, a substantially uniform pit width is obtained.

### 6. Modification Example

The embodiments are described above, however, the technique of the present disclosure is not limited to the embodiments and various modification examples may be considered.

First, the strategy determination process is not limited to the process shown in FIG. 9 described above and various examples may be assumed.

For example, in a case of FIG. 9, the test writing is performed with respect to all candidate strategies TP#1 to TP#n which are prepared and finally the correction amounts are compared.

Besides this, for example, it is the same that the test writing and the correction of the last pulse LP are sequentially performed from the candidate strategy TP#1, however, an example may be considered that when processing a certain candidate strategy TP, if the final correction amount H(x) is within a predetermined range, at this point of time, the test writing is finished and the candidate strategy TP is the optimized strategy. For example, in a case where the candidate strategies TP#1 to TP#5 are prepared, it is an example of the above description in which if the correction amount H3 is a small value within a predetermined range in the candidate strategy TP#3, at this point of time, the candidate strategy TP#3 is the optimized write strategy waveform and the test writing of following candidate strategies TP#4 and TP#5 is not performed and the process is finished. Accordingly, the possibility of reducing the time for the strategy determination process increases.

In addition, as a simple method, a case may be considered that the test writing is not used, for example, all write strategy waveforms corresponding to 2T to 9T. For example, the mark exposure of 4T to 9T may be performed or the mark exposure of only 9T may be performed in the test writing.

The degree of the decrease of the pulse level in the write strategy waveform is exemplified as the constant ratio, however, an example having an inconstant ratio may be considered.

For example, an example may be considered in which the degree of the decrease of the level is suppressed in the pulse of a first half portion of the mark and the degree of the decrease of the level is increased in the pulse of a second half portion with respect to the write strategy waveform of long marks of 6T to 9T.

In the embodiment, the example, in which the technique of the present disclosure is applied to the mastering device, is described, however, the present disclosure may be applied to a recording apparatus with respect to a so-called recordable optical disc.

For example, in optical discs such as BD-R (Blu-ray Disc-Recordable Media), BD-RE (Blu-ray Disc-Rewritable Media) which are currently becoming widespread, grooves which are guide grooves of the recording tracks are formed on the recording surface and an optical disc system in which the grooves are not present on the recording surface is also developed as a next generation optical disc.

Specifically, in the case of an optical disc in which the grooves are not present, since the width direction of the mark which is formed is not restricted by the grooves, the control of the uniformity of the width of the mark is effective. It is preferable that the technique, in which the write strategy waveform where the pulse level is sequentially decreased as described in the embodiment is used, be employed to the recording apparatus corresponding to a recordable-type next generation optical disc.

In addition, the technique of the present disclosure may be applied to a recording apparatus, a mastering device or the like with respect to various recording media such as a card-type (non-circular type) recording medium of a optical recording card, semiconductor exposure mask or the like, a volume-type recording medium (for example, a volume-type hologram recording medium), or the like as well as the optical disc recording medium. In other words, the present disclosure may be applied to the control of the mark in the width direction formed on a recording medium regardless of the shape or type of the recording medium.

In addition, that the mark is capable of being controlled in the width direction is also suitable for an apparatus in which desired shapes, letters, symbols, or the like are described using the mark (the pit). For example, the shape of the mark is able to be optimized in the elliptical shape and thereby the precision of the detailed picture may be improved using the pit.

Further, the present disclosure may be applied to a technique in which the shape of the mark (the pit) is in the droplet shape or the like. Specifically, since the shape of the pit such as a droplet shape, an elliptical shape, a converse droplet shape may be controlled by changing the degree of the decrease of the pulse level, the picture having high degree of freedom using the shape of the pit described above may be realized.

In addition, according to the control of the shape of the mark (the pit) described above, the present disclosure, for example, may be used to add additional information such as a water mark. For example, in addition to recording of the information using the pit column, information which may not be reproduced in the usual reproduction apparatus is able to be embedded by changing the shape of each pit and assembled of the shapes of the pits.

In addition, the present technique may also employ following configurations.

(1) A recording method including: generating a laser driving pulse, of which the number depends on a length of a mark which is formed, and where a pulse level of a pulse column at least in an intermediate pulse besides the lead pulse and the last pulse is sequentially decreased, performing laser emission, based on the laser driving pulse and performing mark formation using thermal recording by laser irradiation on a recording medium.

(2) The recording method according to (1) described above further including, as a write strategy determination process for generating the laser driving pulse,

preparing a plurality of candidate strategies of which degrees of decrease of the pulse level from the intermediate pulse to the last pulse are different from each other,

generating the laser driving pulse by using the candidate strategies and performing a test writing on a recording medium,

performing level correction of the last pulse in order to adjust the length of the mark which is formed on the recording medium using the test writing with the candidate strategies, and

selecting one candidate strategy in the plurality of candidate strategies, based on the correction amount of the level correction and allowing the selected candidate strategy to be a write strategy for generating the laser driving pulse.

(3) The recording method according to (2) described above, wherein candidate strategy having the smallest correction amount of the level correction is the write strategy for generating the laser driving pulse.

(4) The recording method according to (1) to (3) described above, wherein the laser driving pulse is a pulse column which is configured such that the pulse level of the intermediate pulses is sequentially decreased in a constant ratio.

It should be understood by those skilled in the art that various modifications, combinations, sub-combinations and alterations may occur depending on design requirements and other factors insofar as they are within the scope of the appended claims or the equivalents thereof.

What is claimed is:

1. A recording method comprising:
generating a laser driving pulse, of which the number depends on a length of a mark which is formed, and where a pulse level of a pulse column at least in an intermediate pulse besides the lead pulse and the last pulse is sequentially decreased;
performing laser emission, based on the laser driving pulse; and
performing mark formation using thermal recording by laser irradiation on a recording medium.

2. The recording method according to claim 1, further comprising:
as a write strategy determination process for generating the laser driving pulse,
preparing a plurality of candidate strategies of which degrees of decrease of the pulse level from the intermediate pulse to the last pulse are different from each other;
generating the laser driving pulse by using the candidate strategies and performing a test writing on a recording medium;
performing level correction of the last pulse in order to adjust the length of the mark which is formed on the recording medium using the test writing with the candidate strategies; and
selecting one candidate strategy in the plurality of candidate strategies, based on the correction amount of the level correction and allowing the selected candidate strategy to be a write strategy for generating the laser driving pulse.

3. The recording method according to claim 2,
wherein the candidate strategy having the smallest correction amount of the level correction is the write strategy for generating the laser driving pulse.

4. The recording method according to claim 1,
wherein laser driving pulse is a pulse column which is configured such that the pulse level of the intermediate pulses is sequentially decreased in a constant ratio.

5. A recording apparatus comprising:
a laser driving pulse generation section which generates a laser driving pulse of which the number depends on a length of a mark which is formed, and where a pulse level of a pulse column at least in an intermediate pulse besides the lead pulse and the last pulse is sequentially decreased; and
a recording head section which performs laser emission, based on the laser driving pulse and performs mark formation using thermal recording by laser irradiation on a recording medium.

6. The recording apparatus according to claim 5, further comprising:
a control section which performs a write strategy determination process for generating the laser driving pulse,
wherein the control section is provided for,
preparing a plurality of candidate strategies of which degrees of decrease of the pulse level from the intermediate pulse to the last pulse are different from each other;
generating the laser driving pulse by using the candidate strategies and performing a test writing on a recording medium at the laser driving pulse generation section by the recording head section;
performing level correction of the last pulse in order to adjust the length of the mark which is formed on the recording medium using the test writing with the candidate strategies; and
selecting one candidate strategy in the plurality of candidate strategies, based on correction amount of the level correction and allowing the selected candidate strategy to be a write strategy for generating the laser driving pulse.
